(19) United States
(12) Patent Application Publication
(10) Pub. No.: US 2024/0243466 A1
(43) Pub. Date: Jul. 18, 2024

(54) WIRELESS BRIEFING DEVICE

(71) Applicant: BENQ CORPORATION, Taipei City (TW)

(72) Inventors: Yu-Ping Huang, Taipei City (TW); Chun-Han Lin, Taipei City (TW); Chen-Chi Wu, Taipei City (TW); Chia-Nan Shih, Taipei City (TW); Cheng-Pu Lin, Taipei City (TW)

(73) Assignee: BENQ CORPORATION, Taipei City (TW)

(21) Appl. No.: 18/337,051

(22) Filed: Jun. 19, 2023

(30) Foreign Application Priority Data
Jan. 13, 2023 (TW) 112101531

(51) Int. Cl. H01Q 1/52; H01Q 1/48; H01Q 21/06

(52) U.S. Cl. CPC H01Q 1/52; H01Q 1/48; H01Q 21/06

(57) ABSTRACT

A wireless briefing device includes a first antenna, a second antenna, and a ground plane. Each of the first antenna and the second antenna couples out a frequency band. A distance between the first antenna and the ground plane is between 0.2 and 0.3 times of a wavelength of the frequency band, and a distance between the second antenna and the ground plane is between 0.2 and 0.3 times of the wavelength of the frequency band.

### CROSS-REFERENCE TO RELATED APPLICATION

This application claims the priority benefit of Taiwan application serial no. 112101531, filed on Jan. 13, 2023. The entirety of the above-mentioned patent application is hereby incorporated by reference herein and made a part of this specification.

### BACKGROUND

### Technical Field

The invention relates to a briefing device, and particularly relates to a wireless briefing device.

### Description of Related Art

At present, when a wireless briefing device is in use, abnormal image transmission (such as delay, mosaic, black screen or disconnection, etc.) may probably occur. Such situation may not only be affected by an output power of a communication module and image processing performance, but also related to an antenna design.

Conventional antenna is designed on a circuit board. Such type of antenna design makes the antenna susceptible to electromagnetic interference from a ground plane of the circuit board, resulting in poor performance due to receiving noise.

### SUMMARY

The invention is directed to a wireless briefing device, which has better communication performance.

The invention provides a wireless briefing device including a first antenna, a second antenna, and a ground plane. The first antenna couples out a frequency band. The second antenna couples out the frequency band. A distance between the first antenna and the ground plane is between 0.2 and 0.3 times of a wavelength of the frequency band, and a distance between the second antenna and the ground plane is between 0.2 and 0.3 times of the wavelength of the frequency band.

In an embodiment of the invention, a distance between the first antenna and the second antenna is greater than or equal to ⅜ times of the wavelength of the frequency band.

In an embodiment of the invention, the wireless briefing device further includes a casing, the casing is a rectangular casing, and the first antenna and the second antenna are arranged at two diagonal corners of the casing.

In an embodiment of the invention, a material of the casing is an insulating material, and the first antenna and the second antenna are attached to an inner surface of the casing at the two diagonal corners.

In an embodiment of the invention, the wireless briefing device further includes a circuit board separated from the first antenna and the second antenna.

In an embodiment of the invention, the ground plane is located on the circuit board.

In an embodiment of the invention, the distance between the first antenna and the ground plane is between 5 mm and 7 mm, and the distance between the second antenna and the ground plane is between 5 mm and 7 mm.

In an embodiment of the invention, the frequency band is between 5150 MHz and 5850 MHz.

In an embodiment of the invention, the distance between the first antenna and the second antenna is between 70 mm and 80 mm.

In an embodiment of the invention, a polarization direction of the first antenna is the same as a polarization direction of the second antenna.

Based on the above description, in the wireless briefing device of the invention, the first antenna is disposed at a distance from the ground plane between 0.2 and 0.3 times of the wavelength of the frequency band, and the second antenna is disposed at a distance from the ground plane between 0.2 and 0.3 times of the wavelength of the frequency band.

Since the first antenna and the second antenna are separated from the ground plane by a certain distance, the first antenna and the second antenna are less likely to be interfered by the ground plane. In addition, the distance between the first antenna and the second antenna and the ground plane is between 0.2 and 0.3 times of the wavelength of the frequency band, and such design achieves better performance of the antennas.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view of a wireless briefing device according to an embodiment of the invention.

FIG. 2 is a schematic cross-sectional view of the wireless briefing device of FIG. 1 along a section line AA.

FIG. 3 is a schematic diagram of frequency-isolation of a first antenna and a second antenna of the wireless briefing device of FIG. 1.

FIG. 4A and FIG. 4B are schematic diagrams of frequency-return loss of the first antenna and the second antenna.

FIG. 5A and FIG. 5B are schematic diagrams of frequency-VSWR of the first antenna and the second antenna.

FIG. 6A to FIG. 6C are schematic diagrams of radiation patterns of the first antenna at 5150 MHz on different planes.

FIG. 7A to FIG. 7C are schematic diagrams of radiation patterns of the first antenna at 5850 MHz on different planes.

FIG. 8A to FIG. 8C are schematic diagrams of radiation patterns of the second antenna at 5150 MHz on different planes.

FIG. 9A to FIG. 9C are schematic diagrams of radiation patterns of the second antenna at 5850 MHz on different planes.

### DESCRIPTION OF THE EMBODIMENTS

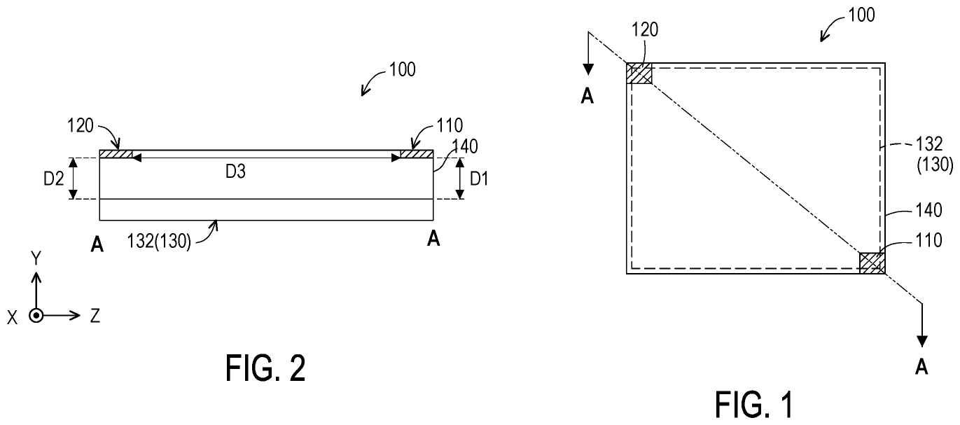

FIG. 1 is a schematic top view of a wireless briefing device according to an embodiment of the invention. FIG. 2 is a schematic cross-sectional view of the wireless briefing device of FIG. 1 along a section line AA. It should be noted that in FIG. 1 and FIG. 2, for simplicity's sake, only antenna-related components in the wireless briefing device are shown.

Referring to FIG. 1 and FIG. 2, a wireless briefing device 100 of the embodiment includes a first antenna 110, a second antenna 120 and a ground plane 132. A frequency band is coupled by the first antenna 110, and the frequency band is coupled by the second antenna 120. Namely, the first antenna 110 and the second antenna 120 are antennas that couple out the same frequency band. In the embodiment, this frequency band is between 5150 MHz and 5850 MHz, but the frequency band is not limited thereto.

In the embodiment, the first antenna 110 and the second antenna 120 are, for example, dipole antennas, and a polarization direction of the first antenna 110 is the same as that of the second antenna 120, which is, for example, an XZ direction. Such design may make radiation patterns of the first antenna 110 and the second antenna 120 to face a same direction for good performance. Certainly, in other embodiments, the types and polarization directions of the first antenna 110 and the second antenna 120 are not limited as above.

In addition, in the embodiment, the wireless briefing device 100 further includes a casing 140 and a circuit board 130. A material of the casing 140 is, for example, an insulating material, and the first antenna 110 and the second antenna 120 are, for example, attached to an inner surface of the casing 140. The circuit board 130 is disposed in the casing 140 away from the first antenna 110 and the second antenna 120 (for example, at a bottom of the casing 140), and the circuit board 130 is separated from the first antenna 110 and the second antenna 120. In the embodiment, the ground plane 132 is located on the circuit board 130. In the embodiment, since the first antenna 110 and the second antenna 120 are respectively separated from the ground plane 132 by a certain distance, the first antenna 110 and the second antenna 120 are less likely to be interfered by the ground plane 132, and may have better performance.

Certainly, in other embodiments, the disposing method and positions of the first antenna 110 and the second antenna 120 on the casing 140 are not limited thereto. In other embodiments, the material of the casing 140 is, for example, metal, and the ground plane 132 may also be a part of the metal casing 140, or the ground plane 132 may also be other metal elements. The material of the casing 140 and the type of the ground plane 132 are not limited thereto.

Further, in the embodiment, a distance D1 between the first antenna 110 and the ground plane 132 is between 0.2 and 0.3 times of a wavelength of the above-mentioned frequency band, and a distance D2 between the second antenna 120 and the ground plane 132 is between 0.2 and 0.3 times of the wavelength of the above-mentioned frequency band. To be specific, taking the frequency band between 5150 MHz and 5850 MHz as an example, the distance between the first antenna 110 and the ground plane 132 is between 5 mm and 7 mm, and the distance between the second antenna 120 and the ground plane 132 is between 5 mm and 7 mm.

The design that the distances D1, D2 between the first antenna 110, the second antenna 120 and the ground plane 132 are between 0.2 and 0.3 times of the wavelength of the frequency band may achieve better performance of the antennas.

Moreover, if the conventional two antennas are placed on a same side of the circuit board, when the two antennas are placed too close together, better antenna radiation pattern cannot be obtained, and even the two antennas interfere with each other. In the embodiment, a distance D3 between the first antenna 110 and the second antenna 120 is greater than or equal to ⅜ times of the wavelength of the frequency band, so as to achieve better performance of the antennas. To be specific, taking the frequency band between 5150 MHz and 5850 MHz as an example, the distance D3 between the first antenna 110 and the second antenna 120 may be between 70 mm and 80 mm.

Further, as shown in FIG. 1, in the embodiment, the casing 140 is a rectangular casing, and the first antenna 110 and the second antenna 120 are disposed at two diagonal corners of the casing 140. The first antenna 110 and the second antenna 120 are, for example, attached to the inner surface of the casing 140 at the two diagonal corners. Such design may make the first antenna 110 and the second antenna 120 as far away from each other as possible to avoid signal interference. Certainly, in other embodiments, the casing 140 may also have other shapes, as long as the distance D3 between the first antenna 110 and the second antenna 120 inside the casing 140 is greater than or equal to ⅜ times of the wavelength of the frequency band.

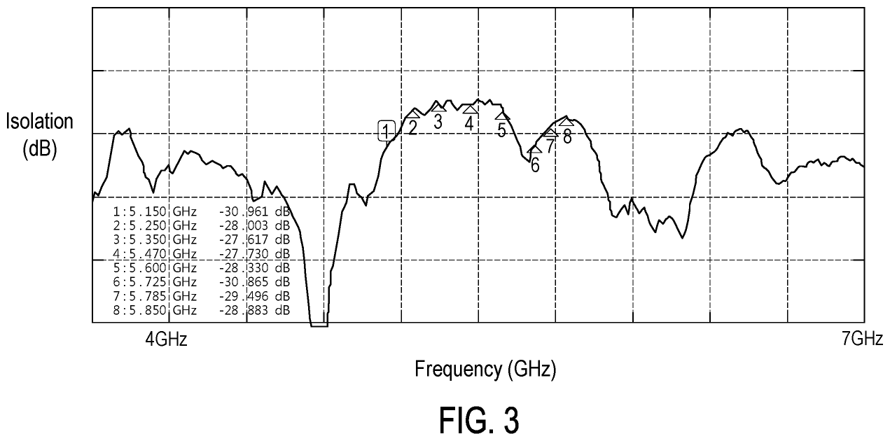

FIG. 3 is a schematic diagram of frequency-isolation of the first antenna and the second antenna of the wireless briefing device of FIG. 1. Referring to FIG. 3, the first antenna 110 and the second antenna 120 of the embodiment have good isolation performance between 5150 MHz and 5850 MHz through the above configuration.

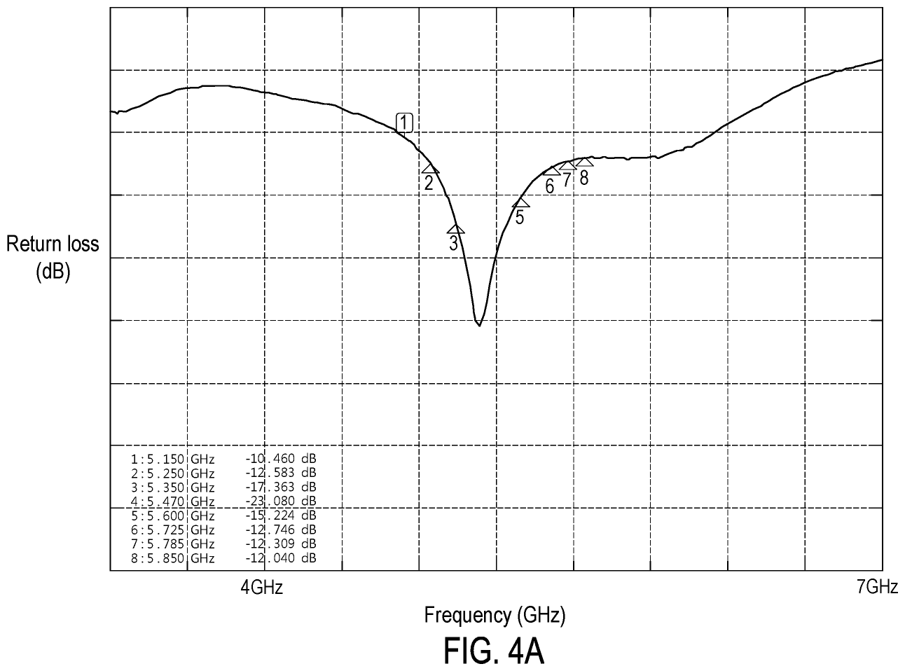

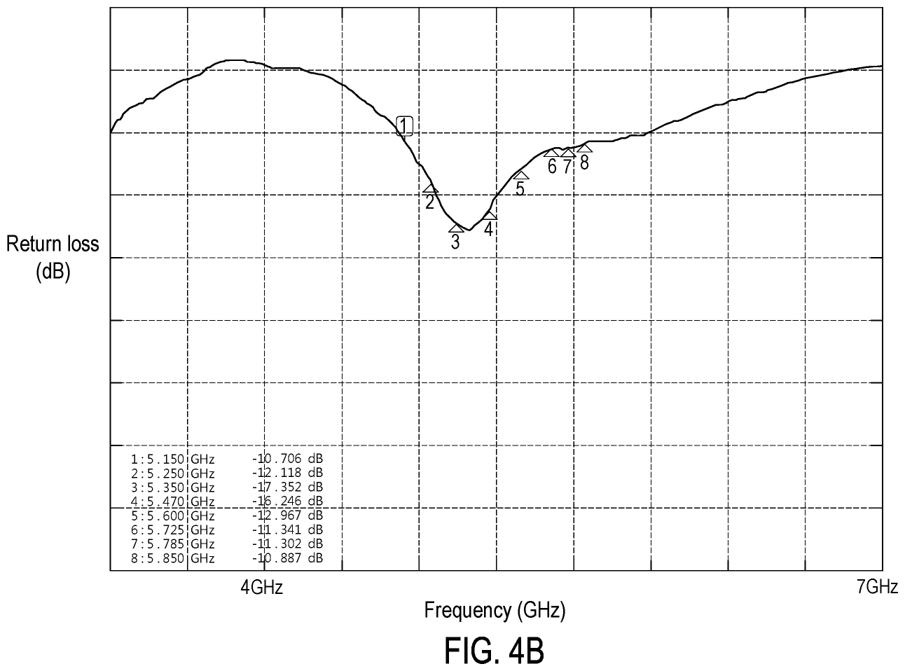

FIG. 4A and FIG. 4B are schematic diagrams of frequency-return loss of the first antenna and the second antenna. Namely, FIG. 4A is a schematic diagram of the frequency-return loss of the first antenna. FIG. 4B is a schematic diagram of the frequency-return loss of the second antenna. Referring to FIG. 4A and FIG. 4B, the first antenna 110 and the second antenna 120 of the embodiment have good return loss performance between 5150 MHz and 5850 MHz through the above configuration.

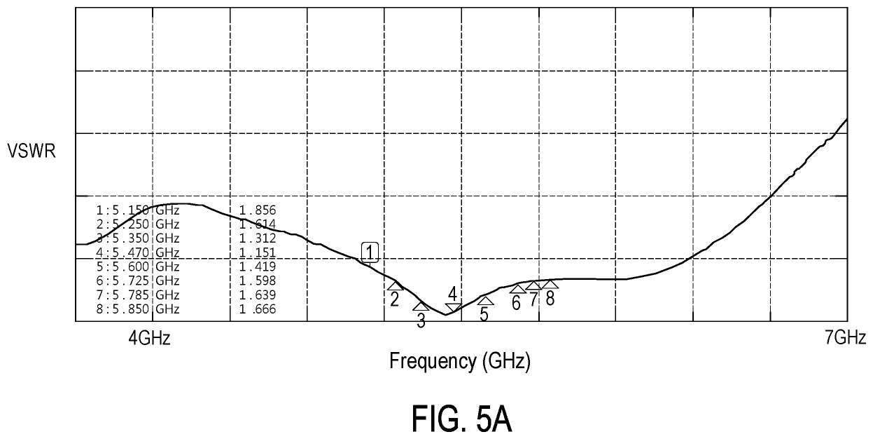

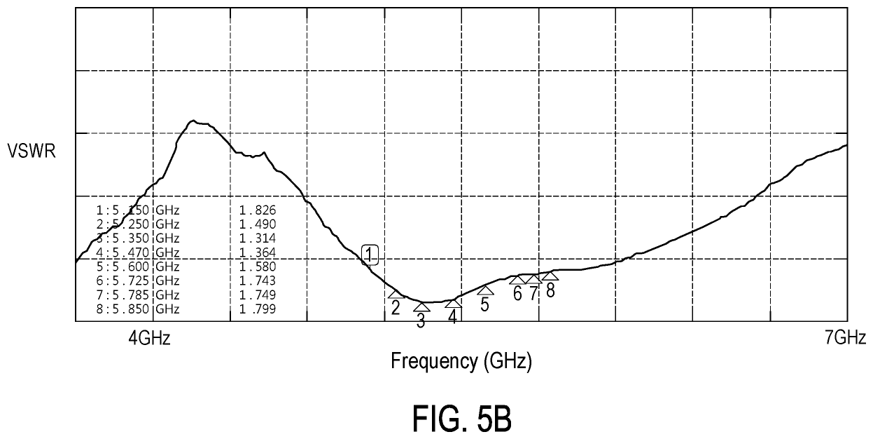

FIG. 5A and FIG. 5B are schematic diagrams of frequency-VSWR of the first antenna and the second antenna. Namely, FIG. 5A is a schematic diagram of frequency-VSWR of the first antenna. FIG. 5B is a schematic diagram of frequency-VSWR of the second antenna. Referring to FIG. 5A and FIG. 5B, through simulation, the first antenna 110 and the second antenna 120 of the embodiment have good VSWR (voltage standing wave ratio) performance between 5150 MHz and 5850 MHz through the above-mentioned configuration.

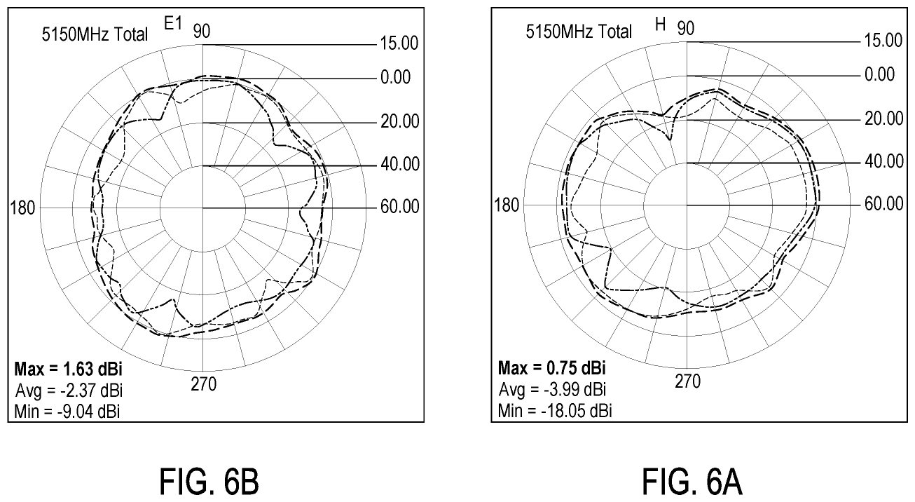

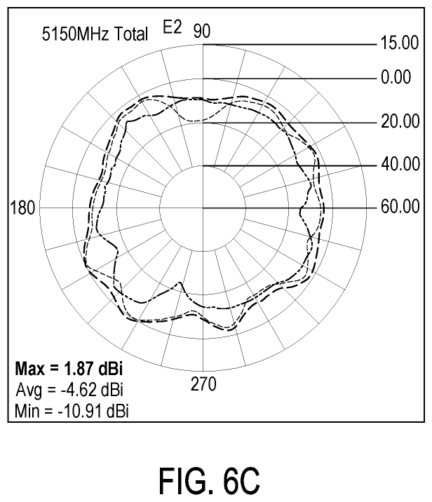

FIG. 6A to FIG. 6C are schematic diagrams of radiation patterns of the first antenna at 5150 MHz on different planes. FIG. 6A is the radiation pattern of the first antenna of FIG. 2 at 5150 MHz on an XZ plane, FIG. 6B is the radiation pattern of the first antenna of FIG. 2 at 5150 MHz on a YZ plane, and FIG. 6C is the radiation pattern of the first antenna of FIG. 2 at 5150 MHz on an XY plane. Referring to FIG. 6A to FIG. 6C, the radiation patterns of the first antenna 110 have good omnidirectional performance in the XZ plane, YZ plane and XY plane at the frequency of 5150 MHz.

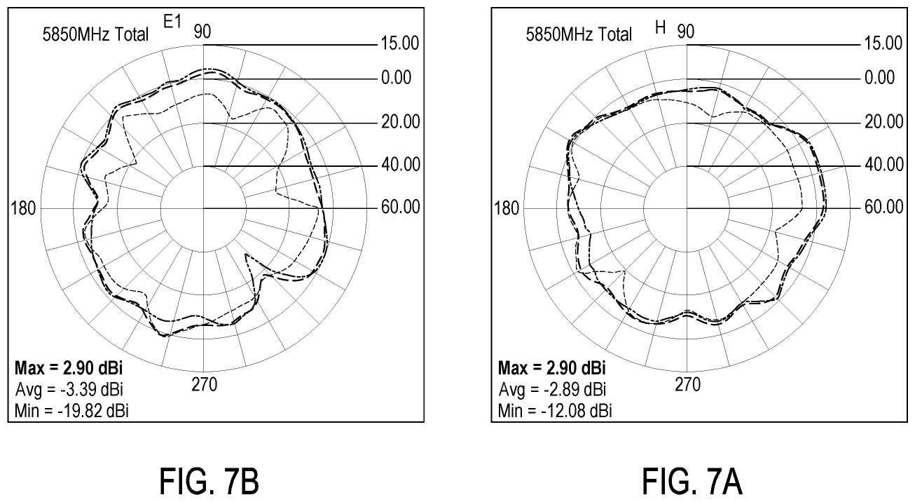

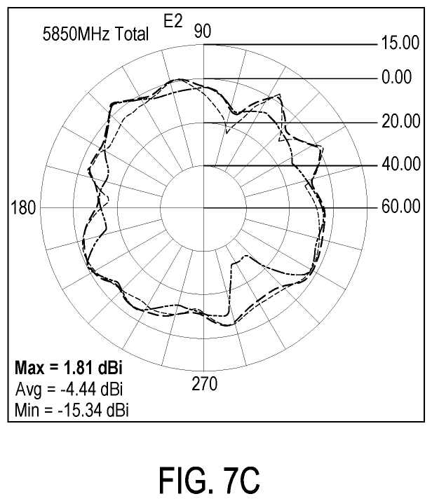

FIG. 7A to FIG. 7C are schematic diagrams of radiation patterns of the first antenna at 5850 MHz on different planes. FIG. 7A is the radiation pattern of the first antenna of FIG. 2 at 5850 MHz on the XZ plane, FIG. 7B is the radiation pattern of the first antenna of FIG. 2 at 5850 MHz on the YZ plane, and FIG. 7C is the radiation pattern of the first antenna of FIG. 2 at 5850 MHz on the XY plane. Referring to FIG. 7A to FIG. 7C, the radiation patterns of the first antenna 110 have good omnidirectional performance in the XZ plane, YZ plane and XY plane at the frequency of 5850 MHz.

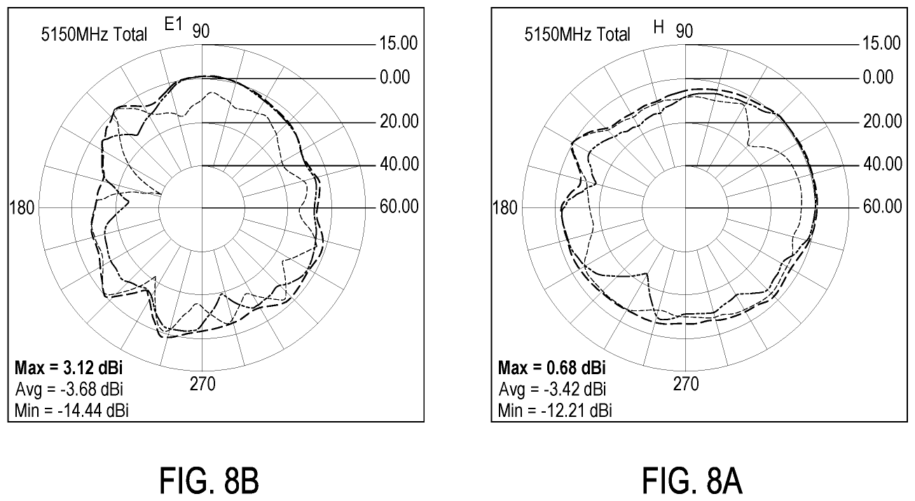

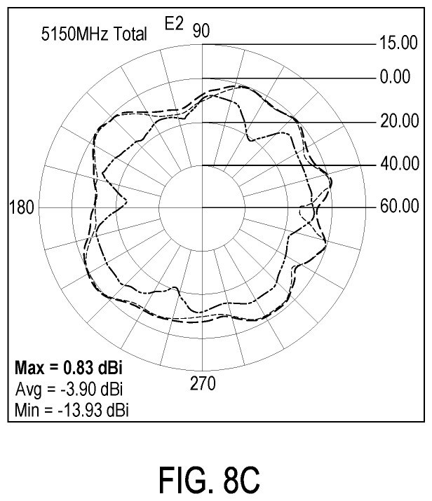

FIG. 8A to FIG. 8C are schematic diagrams of radiation patterns of the second antenna at 5150 MHz on different planes. FIG. 8A is the radiation pattern of the second antenna of FIG. 2 at 5150 MHz on the XZ plane, FIG. 8B is the radiation pattern of the second antenna of FIG. 2 at 5150 MHz on the YZ plane, and FIG. 8C is the radiation pattern of the second antenna of FIG. 2 at 5150 MHz on the XY plane. Referring to FIG. 8A to FIG. 8C, the radiation patterns of the second antenna 120 have good omnidirectional performance in the XZ plane, YZ plane and XY plane at the frequency of 5150 MHz.

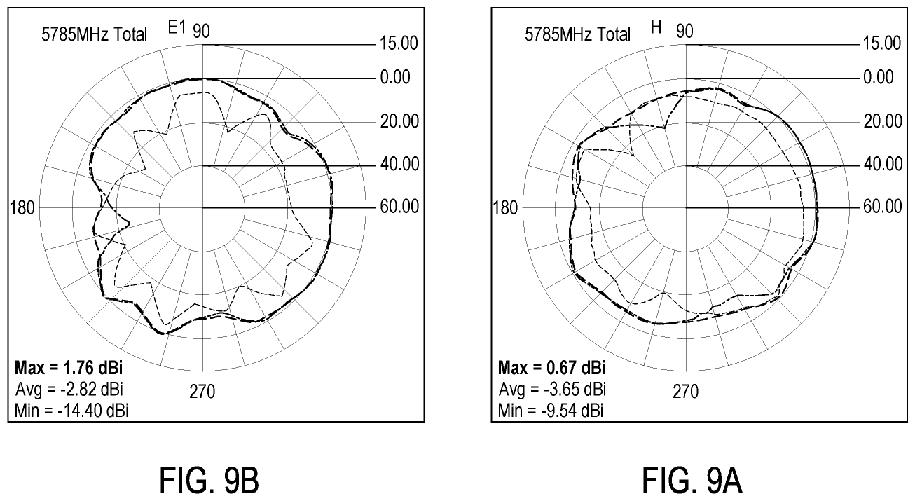

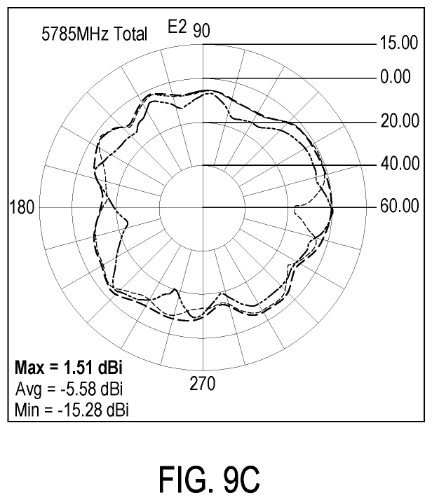

FIG. 9A to FIG. 9C are schematic diagrams of radiation patterns of the second antenna at 5850 MHz on different planes. FIG. 9A is the radiation pattern of the second antenna of FIG. 2 at 5850 MHz on the XZ plane, FIG. 9B is the radiation pattern of the second antenna of FIG. 2 at 5850 MHz on the YZ plane, and FIG. 9C is the radiation pattern of the second antenna of FIG. 2 at 5850 MHz on the XY plane. Referring to FIG. 9A to FIG. 9C, the radiation patterns of the second antenna 120 have good omnidirectional performance in the XZ plane, YZ plane and XY plane at the frequency of 5850 MHz.

In summary, in the wireless briefing device of the invention, the first antenna is disposed at a distance from the ground plane between 0.2 and 0.3 times of the wavelength of the frequency band, and the second antenna is disposed at a distance from the ground plane between 0.2 and 0.3 times of the wavelength of the frequency band. Since the first antenna and the second antenna are separated from the ground plane by a certain distance, the first antenna and the second antenna are less likely to be interfered by the ground plane. In addition, the distance between the first antenna and the second antenna and the ground plane is between 0.2 and 0.3 times of the wavelength of the frequency band, and such design achieves better performance of the antennas.

What is claimed is:

1. A wireless briefing device, comprising:
a first antenna, coupling out a frequency band;
a second antenna, coupling out the frequency band; and
a ground plane, wherein a distance between the first antenna and the ground plane is between 0.2 and 0.3 times of a wavelength of the frequency band, and a distance between the second antenna and the ground plane is between 0.2 and 0.3 times of the wavelength of the frequency band.

2. The wireless briefing device as claimed in claim 1, wherein a distance between the first antenna and the second antenna is greater than or equal to ⅜ times of the wavelength of the frequency band.

3. The wireless briefing device as claimed in claim 1, further comprising a casing, wherein the casing is a rectangular casing, and the first antenna and the second antenna are arranged at two diagonal corners of the casing.

4. The wireless briefing device as claimed in claim 3, wherein a material of the casing is an insulating material, and the first antenna and the second antenna are attached to an inner surface of the casing at the two diagonal corners.

5. The wireless briefing device as claimed in claim 1, further comprising a circuit board separated from the first antenna and the second antenna.

6. The wireless briefing device as claimed in claim 5, wherein the ground plane is located on the circuit board.

7. The wireless briefing device as claimed in claim 6, wherein the distance between the first antenna and the ground plane is between 5 mm and 7 mm, and the distance between the second antenna and the ground plane is between 5 mm and 7 mm.

8. The wireless briefing device as claimed in claim 1, wherein the frequency band is between 5150 MHz and 5850 MHz.

9. The wireless briefing device as claimed in claim 8, wherein a distance between the first antenna and the second antenna is between 70 mm and 80 mm.

10. The wireless briefing device as claimed in claim 1, wherein a polarization direction of the first antenna is the same as a polarization direction of the second antenna.
